(19) United States
(12) Patent Application Publication
(10) Pub. No.: US 2002/0099583 A1
(43) Pub. Date: Jul. 25, 2002

(54) Architecture and techniques for providing product configurations to an enterprise resource planner

(76) Inventors: Lawrence W. Matusek, Gurnee, IL (US); Craig A. Peterson, Hawthorn Woods, IL (US); Michael W. Cochran, Decatur, AL (US)

Correspondence Address: NIXON & VANDERHYE P.C., 8th Floor, 1100 North Glebe Road, Arlington, VA, 22201, US

(21) Appl. No.: 09/768,218

(22) Filed: Jan. 24, 2001

(51) Int. Cl. G06F 17/60

(52) U.S. Cl. 705/7

(57) ABSTRACT

A custom front-end for order entry and pricing with straight-forward integration to a conventional enterprise resource planning (ERP) system allows integration between the custom front-end and the existing ERP system in a straightforward manner without the need to modify the ERP system source code or other functionality. Order-specific data is stored in custom tables created under the ERP database while using standard ERP application classification for maintaining the link to the ERP object and the custom configuration. Custom function modules enable the dynamic transfer of data between the order specific data and the native ERP variant configuration module. The tables provide a middle ground between the ERP application and any number of custom front end interfaces such as web-based applications accessible via intranets and/or the Internet.

### FIELD OF THE INVENTION

The present invention relates to product configurator/resource planning systems, and more particularly, to techniques for connecting Internet-based and other applications to product variant configurator components. More particularly, the invention relates to an external application that can be used to replace the product variant configurator of an enterprise resource planning (ERP) application so as to allow users to create product configurations outside of the normal variant configuration transactions in the ERP system while continuing to take advantage of other ERP application functionality. In still more detail, the present invention provides a system architecture for configuring and selling products in external applications and reading the sales and configuration data in a ERP system to trigger transactions and explode configurable bills of materials and task lists.

### BACKGROUND AND SUMMARY OF THE INVENTION

Before the industrial age, most products were made to order by individual craftsmen and craftswomen based on customer specifications. For example, the village blacksmith would make his customers precisely the type of tools they wanted, the weaver would weave a blanket in the colors and materials the customer asked for, and the silversmith would make the precise jewelry or tea set in a design that struck the customer's fancy. While custom made-to-order goods had the advantage of giving customers exactly what they wanted, manufacturers eventually found that tremendous cost savings could be achieved through mass production. Factory mass-production of high quality products transformed the world's economy and made goods available to those who previously might not have been able to afford them.

While most of the goods bought today are mass produced, there are still certain goods that can or should be custom ordered. For example, if you have ever bought a new car, you know that there are a variety of different options you can request. For example, you may be able to choose:

different exterior paint colors, styles and options (e.g. pin striping);

interior colors;

upholstery and style of the seats (e.g., leather or cloth, bench or bucket);

engine size;

different sound systems; and

other options and variations.

This form of custom manufacturing makes available a number of customer-selectable product variations. The customer can configure the product by, for example, selecting from a menu of options. The product can still be mass produced on a factory floor from standard components, but the manufacturer can build each individual product to order based on the customer's selection. Such techniques can be applied to a variety of products in addition, to automobiles including, for example:

houses

kitchens

bathrooms

business forms

personalized stationary

personal computing equipment

factory equipment

testing equipment

pipes and conduits

clothing

home furnishings

other products.

Enterprise resource planning (ERP) software is widely used to offer configurable products and services to customers. Such software is typically available with a pricing and configurator module that allows customers to access a merchant's Web site, check configuration options for products and services they would like to purchase, and evaluate the options and pricing (e.g., in real time). Such pricing and configuration tools give customers the ability to design their products and price out the products.

Particular merchants may wish to provide customized product configurators for particular products. However, typical, commercially available ERP software is generally designed to be general purpose and is hence typically not easily customized to particular applications. While ERP software allows some degree of customization and/or integration with external functionality, the efficiency, functionality and maintainability of the customized functionality has been problematic in the past.

Most ERP product configurators require users to perform all product configuration using specific, defined transactions within the ERP system. In most ERP systems, these transactions operate using a highly generic user interface that has limited presentation capabilities and can be difficult to navigate. Furthermore, accommodating a customer with a special request that is not predefined for a particular product may require making additional order-specific entries manually. Because the configuration must take place as part of another transaction, business processes may have to be altered to accommodate the ERP system. In contrast, it would be much more desirable to provide a flexible ERP product configurator front-end that can be adapted to the underlying business processes.

One known approach to enhancing ERP system product configurator flexibility is to interface an external application with various modules of the ERP system. In general, interfaces exchange data and/or trigger transactions between an external application and an ERP system by mapping a data structure and/or transaction in the external application to a data structure and/or transaction defined within the ERP system. Often, the data structures in an external application are somewhat dissimilar to the data structures in the ERP system. Data mapping and synchronization therefore become challenges with the interface approach. Configuration data can be very difficult to map since the number of data fields, the formats of data fields, and the allowed values of data fields are all user-defined. When data structures, data values or data validation rules change, a coordinated effort must take place to ensure that the interface continues to function properly. In addition, error handling routines are often needed to handle situations where one system cannot interpret or allow data sent by the other. Further, most interfaces run periodically rather than in real-time. This can raise issues about the timing of data transfers and how to handle situations where one system is running while the other one is down.

Another known approach is to use an external system to replicate all necessary data of an ERP system. One example of this approach is the R/3 SCE (stand-alone configuration engine) and SPE (stand-alone pricing engine) offered by SAP Aktiendesellschaft of Walldorf Germany. In general, SAP's R/3 ERP system creates a knowledge base of all pertinent master data, classification data, configuration data and configuration rules in a format that can be used by external applications to create and validate sales documents that contain configurable materials. However, configuration replicators require the creation of a knowledge base that effectively contains all of the information needed during the creation of a product configuration. For complex configurable materials (e.g., especially those that read other master data), the knowledge base may be extremely large and difficult to manage. As with any replication, it may be quite complicated to provide necessary conflict resolution functionality. There can also be mapping issues similar to interfaces. Additionally, some configuration replicators do not offer functionality for working with configured materials (e.g., stockable types).

Hence, while much work has been done in the past, further improvements are possible and desirable.

The present invention solves this problem by providing a custom front-end for order entry and pricing with straight-forward integration to a conventional ERP system. The invention allows integration between the custom front-end and the existing ERP system in a straight-forward manner without the need to modify the ERP system source code or other functionality.

One aspect of the present invention leverages the native capabilities of a preexisting ERP system to create order-specific operation lists, components and the like while enabling external access via web or external applications, for example. The current method of data storage in certain ERP applications potentially makes this interface very complicated and nearly impossible to maintain. However, a preferred embodiment of the present invention stores the order-specific data in custom tables (i.e., created and stored in the ERP database) while using standard ERP application classification for maintaining the link to the ERP object and the custom configuration. Data consistency between the ERP application and the external interface application is maintained through the use of tables providing the allowed values the user sees when, for example, they click on a drop-down list in the external application. Custom function modules enable the dynamic transfer of data between the order specific data and the native ERP variant configuration module.

The preferred embodiment provides custom data tables for storing order specific data. These custom tables are created and stored in the ERP system database. Standard ERP system classification is used to maintain linkages between objects within the ERP system environment and an external custom configuration front-end. Custom external function modules may also be provided for enabling the dynamic transfer of data between order specific data and the native ERP variant configuration model functionality.

In the preferred embodiment, the external front-end can provide Internet (e.g., Web-based) connectivity, and can be designed to provide whatever functionality the merchant wishes. This customizable front-end interfaces seamlessly with the ERP software system via the custom tables in the ERP software system database that can be shared with other external front-end applications for different merchants and/or business models. Certain tables can be used to control allowed configuration options. Other tables may be product-specific and store individual customer specific configurations. The resulting simplified order entry process provides a better and more flexible user interface, with increased processing performance and data storage efficiency, expanded version and status control and improved data administration capabilities.

A preferred embodiment of the invention allows users to create product configurations outside of the normal variant configuration transactions in an ERP system. For example, using the custom front-end, configurable materials can use a single configuration ID characteristic to provide the necessary linkage between the configuration data that is native to the ERP system and the configuration data that is stored in custom tables. The disclosed system can be used to configure single-level or multi-level products in an external application—even in circumstances where native configuration functionality of the ERP system is limited to single-level. Version management can be handled in the external application, and product configurations can be created programmatically by external applications such as data processing programs or process control systems.

The preferred embodiment also makes it possible for detailed product configurations to be created before or after the ERP variant configuration transactions, and makes it feasible to automatically create configured material masters, bill of material links and/or sales orders with configured items from the product configuration (e.g., by reading product configurations and triggering programs within the ERP system where appropriate).

The preferred embodiment system can be used as businessware to trigger transactions of all types in ERP systems. It may also be used as a means of grouping and selling combinations of items. The system also can be used to provide businessware to control production, stocking and releases of warehouse materials, such as forms management programs. The system may also aggregate numerous similar or associated products into one production run (e.g., business communications services). Configuration data can come from multiple front-end applications including those that are stand alone, server based, intranet based or Internet based. Field personnel only need to access an intranet or the Internet—not the underlying ERP system. Customer self-service applications can be created without giving customers direct access to the underlying ERP system, and data fields in custom configuration tables are not subject to the same restrictions that apply to the underlying ERP native applications. Additionally, update queries can be used to perform mass maintenance on data stored in custom configuration tables, and multiple materials or sales order items can share the same product configuration.

The preferred embodiment of the present invention allows a user of an ERP system to develop a custom front-end for order entry and pricing with straightforward integration to the ERP system without the need to modify the ERP system source code. The interaction of the tables and the data consistency provided by the preferred embodiment can be generically applied to most make-to-order configurations of an ERP system.

In addition to those discussed above, the preferred embodiment of the present application provides the following additional advantageous features and/or advantages:

business ware to trigger transactions of all types in ERP systems,

a means of grouping and selling combinations of items (also known as kitting),

business ware to control production, stocking and releases of warehoused materials (e.g., forms management programs),

a means of aggregating numerous similar or associated products into one production run (e.g., business communications services)

configuration data can come from multiple front-end applications including applications that are stand-alone, server based, intranet-based or Internet-based,

field personnel can interface and access to an intranet or the Internet, and need not access the ERP system directly,

customer self-service applications can be created without giving customers direct access to the ERP system,

data fields and custom configuration tables are not restricted to the same parameters as the native ERP data structures (e.g., character length and other limitations),

update queries can be used to perform mass maintenance on data storage configuration tables,

multiple materials or sales order items can share the same product configuration,

provides applications to any business or other user that buys, sells and/or manufactures customized products.

### BRIEF DESCRIPTION OF THE DRAWINGS

These and other features and advantages provided by the invention will be better and more completely understood by referring to the following detailed description of presently preferred embodiments in conjunction with the drawings, of which:

FIG. 1 shows an example prior art ERP system interfacing to an external application;

FIG. 2 shows a presently preferred example embodiment of an ERP system including customized configuration and control tables providing a shared middle ground between the ERP system and external applications such as network-based front-end products;

FIG. 2A is a flowchart of an example variant function technique; and

FIGS. 3-10 show example customized tables for a particular business form product configuration application.

### DETAILED DESCRIPTION OF EXAMPLE EMBODIMENTS

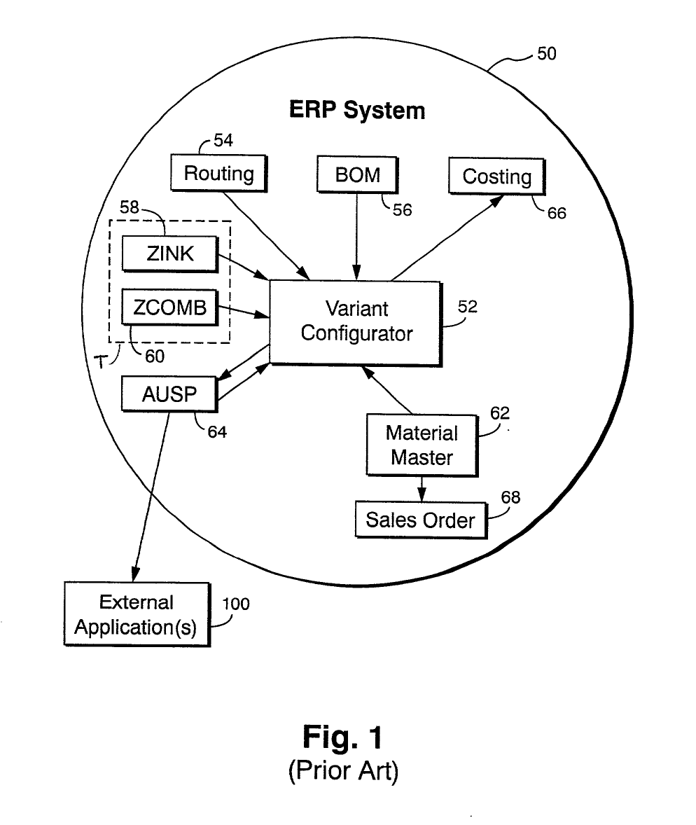

FIG. 1 shows an example prior art electronic enterprise resource planning (ERP) system 50 including a variant configurator 52. ERP system 50 is used, for example, to allow a customer to configure a product he or she wishes to have manufactured. Numerous products are manufactured in a vast range of variants. For example, if you have ever ordered a new car you know about all of the various options and decisions you need to make in order to configure the vehicle. You may select between different engines, different interior trim, different wheel styles, different radios or sound systems, and the like. Other products that are commonly built to order include personal computers, houses, kitchens, business forms, tooling, and a wide range of industrial machines and products. The conventional variant configurator 52 shown in FIG. 1 is a tool for defining complex/customized products with numerous manufacturing options.

In the example shown, the ERP system 50 includes, in addition to the variant configurator 52 function, several other functions including for example:

routing function 54,

bill of materials (BOM) explosion function 56,

costing function 66,

material master function 62, and

sales order function 68.

In the example embodiment, the routing function 54 provides routing information; the BOM explosion function 56 allows the ERP system 50 to explode a bill of materials; the costing function 66 provides component and combination cost breakdowns; the material master function 62 provides a master material list; and the sales order function 68 generates and processes an order based on the variant configurator functionality. The variant configurator 52 may interact with routing information provided by a routing information function 54; bill of materials (BOM) information from a BOM function 56; and configuration data from certain native tables 58, 60 within the ERP system database. Tables 58, 60 may, for example, store available product options for a range of possible product configurations.

In the example shown, a set of tables T within the ERP system database is used to provide product variant configuration information. In one particular example where ERP system 50 is used to configure business forms, tables T comprise a table 58 (called “ZINK”) storing data for a number of available ink colors (e.g., color code, PMS number, shade and description); and a table 60 (called “ZCOMB”) storing data for a number of paper and carbon types (e.g., combination key, color, weight, grade, caliber and usage). When used for configuring other types of products, tables T would provide product configuration data for the particular type of product being configured.

In the FIG. 1 example, configuration is performed by a ERP system material master function 62 using a user interface provided by variant configurator 52. Essentially, the product configurator 52 provides a user interface that a customer can interact with to choose between various production configuration options as defined by tables T. The user interface may provide a variety of different views (e.g., a sales view, a document management view and a manufacturing view) to allow users to describe and efficiently manage all of the different variants of a product known to the ERP system without the need to duplicate data. The resulting product configuration profile 64 generated by a user interacting with the variant configurator 52 comprises a cross-application AUSP table that can be read by external application(s) 100 but cannot be modified. This allows recalculation/reanalysis by variant configurator 52 without using complex interfaces.

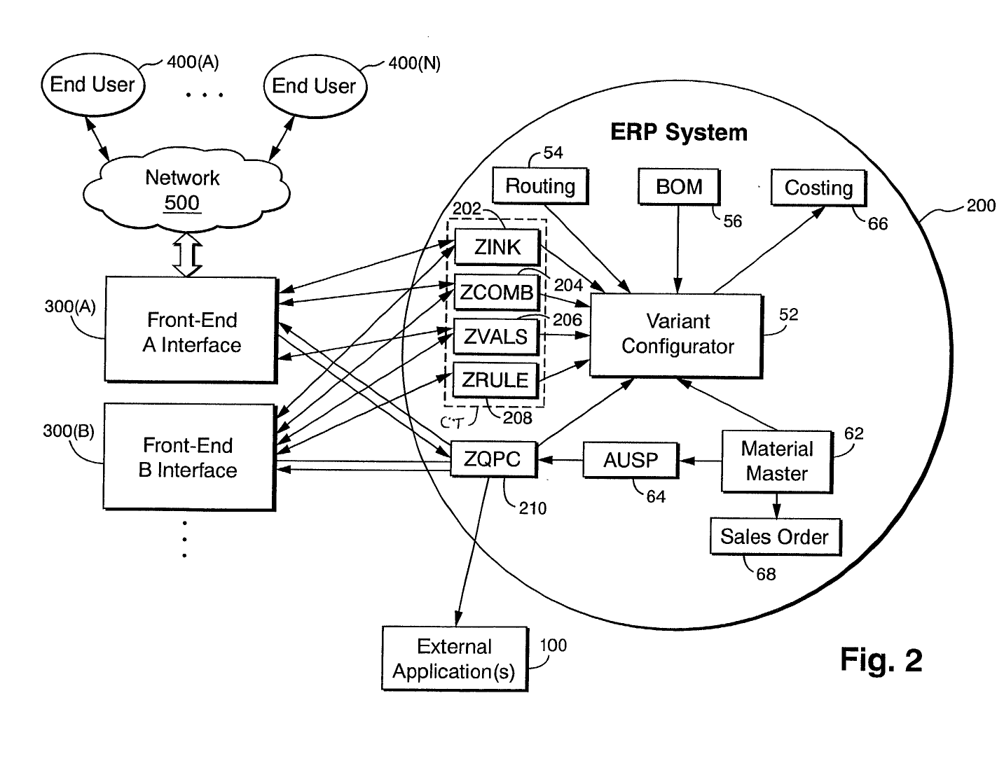

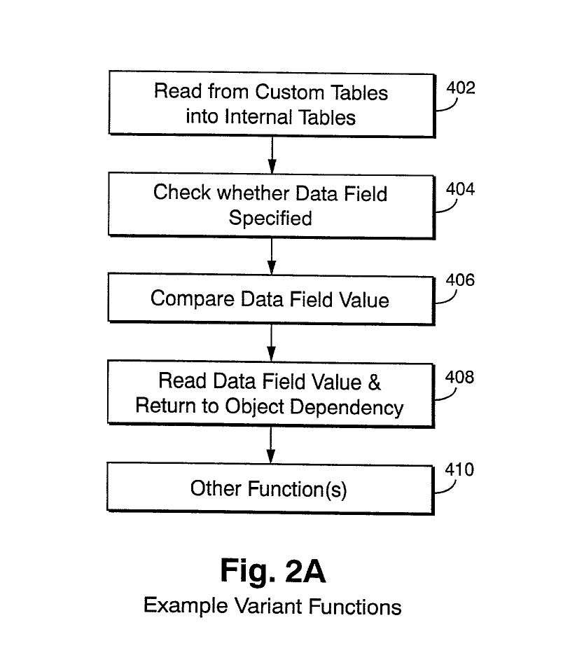

FIG. 2 shows an improved ERP system 200 provided by a preferred embodiment in accordance with the invention. Unlike the prior art situation shown in FIG. 1, the FIG. 2 example embodiment includes custom tables CT within the ERP system database that are shared with various external “front-end” applications. In the example embodiment, these shared tables comprise a middle ground between the ERP system 200 and the external front end applications 300 in the sense that the front end applications can read from and/or write to the tables, but the tables are also understandable by (and actually included within the database of) ERP system 200. In the example embodiment, the customer uses the front end applications 300 (as opposed to the user interface provided by variant configurator 52) to interact with and define the contents of tables CT. Once the tables are defined, product variant configurator 52 can process the table contents to configure a product, obtain a bill of materials, cost information, etc., and generate a material master and associated sales order.

In more detail, custom tables CT in this particular example comprise four tables 202, 204, 206, 208 used to control the allowed configuration options manipulated by variant configurator 52. Each of these tables are readable and changeable by front-end interface(s) 300(A), 300(B), . . . An additional table 210 (ZQPC) storing individual customer-specific configurations may also be accessed, written to and read from by the front-end interfaces 300. The resulting improved ERP system 200 provides simplified order entry processing using a better and more flexible user interface, provides increased processing performance and data storage efficiency, allows for expanded version and status control, and provides improved data administration capabilities.

In more detail, tables 202, 204, 206, 208 and 210 comprise centralized custom tables that are not native to the external applications 100, 300 or the ERP system 200. In effect, these custom tables are shared middle ground between external applications and ERP system 200. In the preferred embodiment, the custom tables reside within the database of ERP system 200 because that database is a controlled, centralized environment which gives data-intensive ERP processes (e.g., MRP, bill of materials explosion 56, and task list explosion functions) fast, uninterruptable access to the tables. However, in other embodiments the tables could be maintained outside of the ERP system 200 database and the ERP system could be given access to them through periodic importing and/or other arrangements.

In the example embodiment, the custom tables CT are in two different categories:

configuration tables, and

control tables.

Configuration tables store product configuration data in the example embodiment. Various tables can be used to store configuration data for highly dissimilar products and/or multiple levels of a single product. For example, the form-specific configuration data for a three-part business form can be stored in a single record of a form level table called ZFORM while the part-specific configuration data can be stored in three records of a part-level table called ZPART. In the example embodiment, the configuration tables contain all of the data that variant configurator 52 stores within its AUSP table 64. In the example embodiment, any authorized application (including front-end interfaces 300) can read, write, append or delete data from the configuration tables at almost any time.

The FIG. 2 embodiment also provides control tables storing allowed values and data validation rules. Numerous control tables can be created, but three specific control tables are recommended. One table contains allowed values and their descriptions for a given data element in a given product. For example, this table may contain data similar to that stored by the SAPR/3CAWN table. The second table contains field-level validation rules and messages to be displayed if the rules are violated. There can be one (or more) validation rule per field per product. The third table may contain record level validation rules and messages if the rules are violated. There can be any number of validation rules per record per product. A record must, in the example embodiment, satisfy all record level rules to be considered valid.

Check tables are another example of custom control tables that may be provided within the FIG. 2 embodiment. For example, a custom check table for characteristic allowed values may be provided in the form of a custom control table. Unlike the configuration tables which are writable/changeable by the front-end interfaces 300 and other external applications, the control tables in the example embodiment are read-only to all external applications and are preferably updatable only through a secure, structured procedure to prevent end users from changing the control information they contain.

### Business Processes

In general, the preferred embodiment shown in FIG. 2 allows users to create product configurations outside of the normal variant configuration transactions of ERP system 200. The preferred example embodiment allows configurable materials to require only a single configuration ID characteristic to provide the necessary link between the configuration data that is native to ERP system 200 and the configuration data that is stored in the custom tables. The configuration ID characteristic value corresponds to the value of the first field of the primary key of each custom configuration table in the example embodiment.

The preferred example embodiment of FIG. 2 can be used to configure single-level or multi-level products in an external application—even though the configuration within the ERP system 200 itself may be only or always single-level. Engineering change management can be handled in the external application 100, 300 using versions with configuration effective dates and/or within the ERP system 200. In addition, the preferred embodiment shown in FIG. 2 allows product configuration to be created programmatically by external applications such as data processing programs or process control systems.

The FIG. 2 preferred example embodiment makes it possible for detailed product configurations to be created before or after the ERP variant configuration transactions. It also makes it feasible to allow the conventional ERP application to automatically create configured material masters, bill of material links and/or sales orders with configured items from the product configuration developed via the external front end(s) 300. This could be accomplished, for example, by reading product configurations and triggering programs within the ERP system when appropriate.

### External Applications

To fully realize the advantages of the preferred embodiment, external interfaces 300 may store configuration data directly in the custom configuration tables. Storing configuration data in a different structure and then transferring it into the custom configuration tables is also possible, but may result in inefficiencies. Assuming that the data in the custom control tables does not change frequently, snapshots of these tables can be created within the database of the external applications 300 to eliminate unnecessary network or messaging traffic. This can be done, for example, using SQL database queries via ODBC, IDOC's, API's or other means.

Most allowed values and validation rules may be read from the control tables rather than stored directly in external applications 300. Using this approach, all external applications 300 can be updated at once by maintaining the control tables centrally. External applications can query the allowed values control table to get a list of allowed values for all fields with a given data element in a given product type. These applications can query the field validation control table to get the validation rule for a given field in a given product type. Likewise, these applications can query the record validation control table to get validation rules for a given product type.

Validation and presentation rules that are not subject to change can be built directly into the external applications 300. For example, if two fields are mutually exclusive, the external application can delete the value of the second field if a value is entered into the first field.

It may be useful to extract snapshots of certain ERP master data (e.g., material inventory levels) periodically. If this data changes frequently, however, it may be better to read it from the ERP system in real time. Temporary working tables are also recommended. These tables reside within the external application database and may store intermediate calculations or configuration data for the product currently being configured.

### Configurable Bills of Material and Task Lists

In the example embodiment, all material requirements planning, capacity planning, scheduling, shop for control, costing and so on can be done in the ERP system 200 using native, conventional functionality. Variant functions are used to read data in the custom configuration tables. In general, these functions read records where the first field of the primary key in a custom configuration table is equal to the configuration ID characteristic value stored in the variant configuration of the ERP system 200.

Numerous variant functions can be created. In one specific arrangement, four specific functions are recommended:

read records from custom configuration tables into internal tables (FIG. 2A, block 402),

check whether a data field has been specified (FIG. 2A, block 404),

compare data field value to other values (FIG. 2A, block 406), and

read values from a data field and return them to an object dependency for further processing (FIG. 2A, block 408).

The first variant function (402) of reading appropriate records from the custom configuration tables into internal tables would typically be run before all others and would allow all subsequent variant functions to read configuration data from memory without having to continually query the database. The arguments for this function might include, for example, the configuration ID characteristic. This function would not necessarily return any values.

“Check” variant function 404 checks whether a data field has been specified. The arguments for this function 404 may include the name of the field to read, and a variable that identifies which internal table to read. This function 404 may return a pass/fail decision in the example embodiment.

The “compare” variant function 406 may be used to compare the value in a data field to other values. The arguments for this function 406 in the example embodiment include the name of the field to read and the comparisons to make (e.g., less than or equal to a value, greater than or equal to a value, equal to a value, and so on). The function 406 in the example embodiment returns a pass/fail decision.

The “read and return” variant function 408 in the example embodiment reads values from a data field and returns them to an object dependency for further processing. In the example embodiment, the arguments for this function include the name of the field to read and a variable that identifies which internal table to read. Example function 408 in this embodiment may provide a number and/or character string equivalent to the value of the data field.

In the example embodiment, these various functions 402, 404, 406, 408, 410 may use indirect references to read data. They can also use reference characteristics to read data fields from bill of material components, routing operations or sequences, etc. This can dramatically reduce the number of object dependencies that are needed.

Since there is only one characteristic per configurable material in the example embodiment, conventional class node material lookups in a bill of material are not available. It is possible, however, to create numerous class nodes that contain only the configuration ID characteristic. A user exit for selecting an object from a class node can be written to read custom configuration tables (e.g., using the configuration ID characteristic in the class node) to return an appropriate material number (e.g., based on the name of the class node) into a bill of material item. In one specific example, the SAP R/3 ERP system provides user exit CCUX0002 which can be used to return the appropriate material number if a class node search does not find any suitable materials or finds more than one suitable material.

The main caveat to this type of class node lookup is the maintenance of MRP low level codes. ERP systems automatically maintain these codes when conventional class nodes are used, but will not do so in the example embodiment. It is possible to maintain these codes manually or programmatically by allocating materials to the appropriate class nodes (the characteristic value need not be entered) and entering the class nodes into bills of material with the appropriate hierarchy. Failure to maintain MRP low level codes properly could result in incorrect MRP planning, costing errors, and so on. Since bill of material hierarchies vary with the products being configured, users should preferably thoroughly understand how and when to set low level codes. If it is possible to define the bill of material hierarchies in advance, product configuration data could be used to programmatically set materials to the appropriate low level code.

To fully realize the power of the example embodiment shown in FIG. 2, all routing calculations can be performed in variant configuration functions called from object dependencies allocated to the first non-base sequence added to a routing. The results of these calculations may be stored in global internal tables referenced by variant configuration functions called by object dependencies (e.g., to include or infer values, into operations and/or sequences). In addition, routing calculations could be performed outside of a routing by calling the appropriate function modules.

The same approach could be applied to bills of materials by performing the material requirement calculations and variant configuration functions called from object dependencies allocated to the first component (e.g., preferably a text item) added to a bill of material. The results of such calculations may be stored in global internal tables and referenced by variant functions called by object dependencies allocated to subsequent components in the bill of material. Like the routing, material requirement calculations could be performed outside the bill of material explosion by calling the appropriate function modules.

As a further example, system 200 can provide a way to read the configuration key and the table that configuration is stored in directly from fields in the material master 62 without the need for any additional characteristics. An all-purpose function (e.g., “ZREAD”) can be used to read custom tables by name, field, and configuration ID. An additional function may be used to modify the structure of the VQPC table 210 dynamically as well as to modify the structure of other tables. Other possible functions provided by preferred embodiment 200 shown in FIG. 2 include a process for changing the values in the various tables (value changing or editing is more complicated than value adding or appending). In one particular business form application, the length and width fields within the various tables provide five decimal accuracy. Whole count, spacing and location may be combined into one field to control valid combinations. A version number field may also be included if desired. It may be desirable also to describe the data types of the underlying ERP system 200. Validation can be done upon update via the consistency check. It may be desirable to provide a reporting function that finds inconsistent configurations within ZQPC 210 based upon changes in the other custom tables. Changes could be tracked in a separate table to improve performance. Similarly, long texts might be moved to a separate table (once again to improve performance). Any additional number of tables can be used to provide for allowed values in external applications.

### Example Specific Implementation

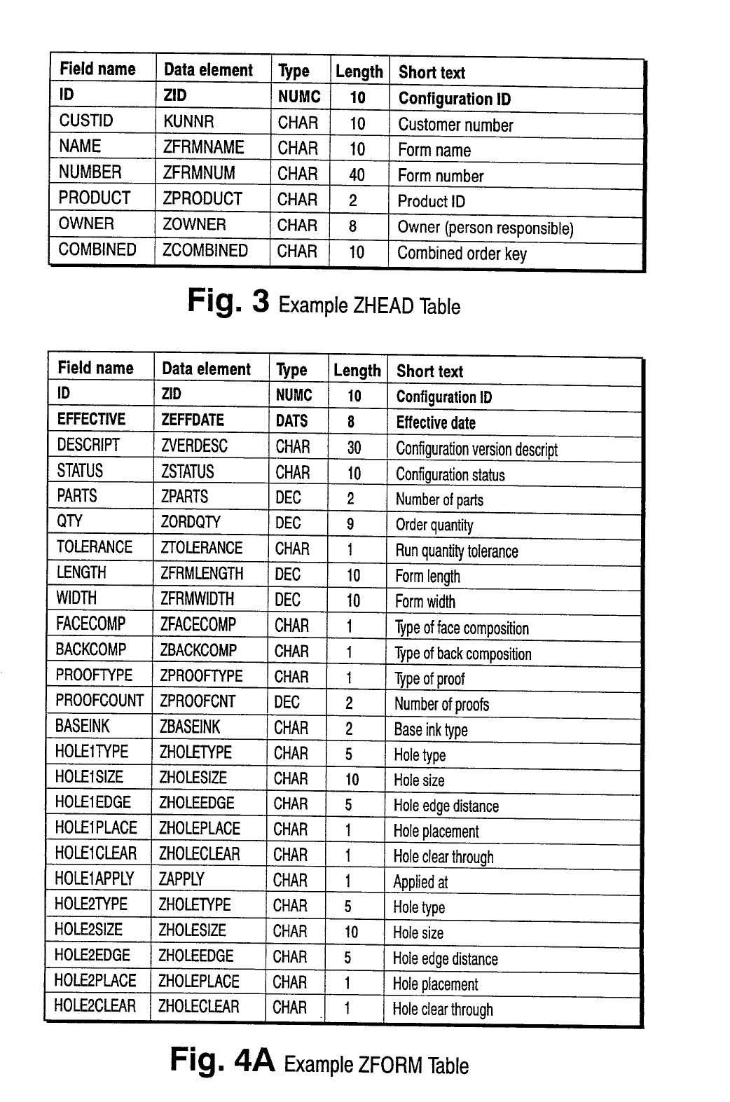

FIGS. 3-10 show example specific data structures for a particular business form (e.g., non-label product). FIG. 3 shows an example header level table (“ZHEAD”) providing header level data for each configuration. Each record within the ZHEAD table in the example embodiment provides header level information for a particular configuration, with the ID field being the key field for the record.

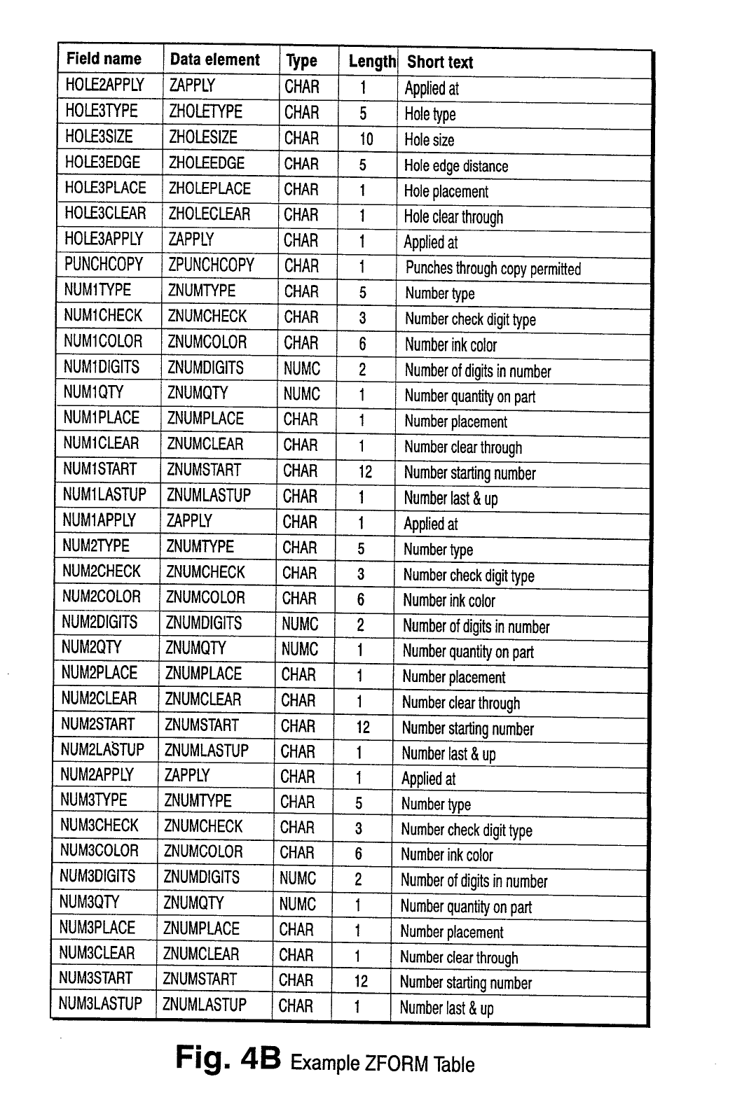

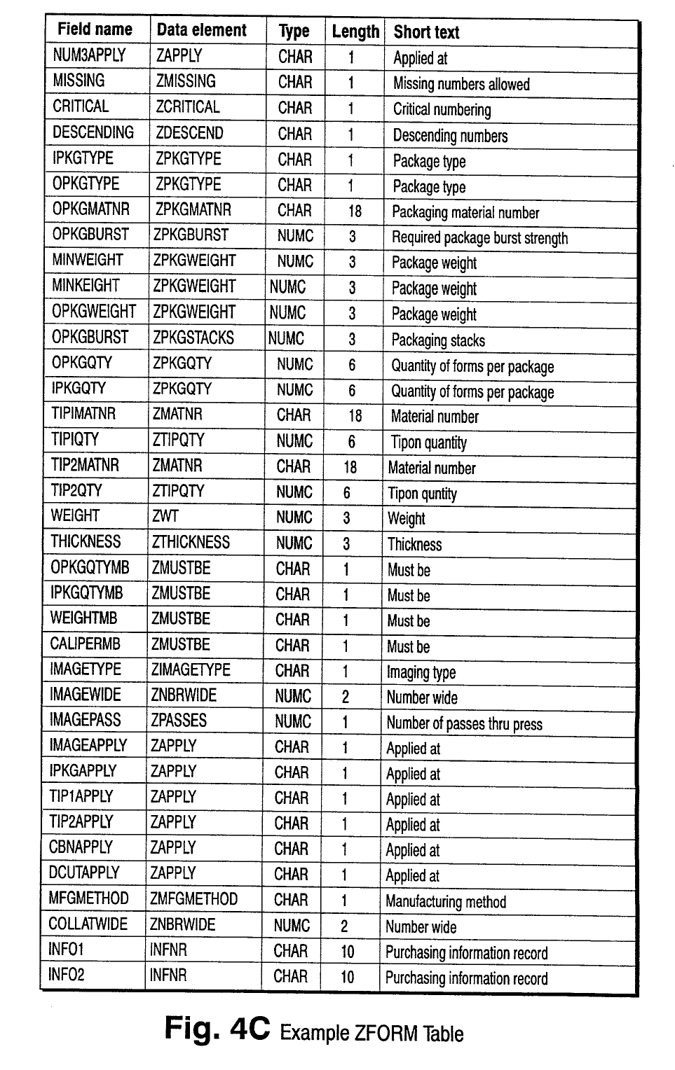

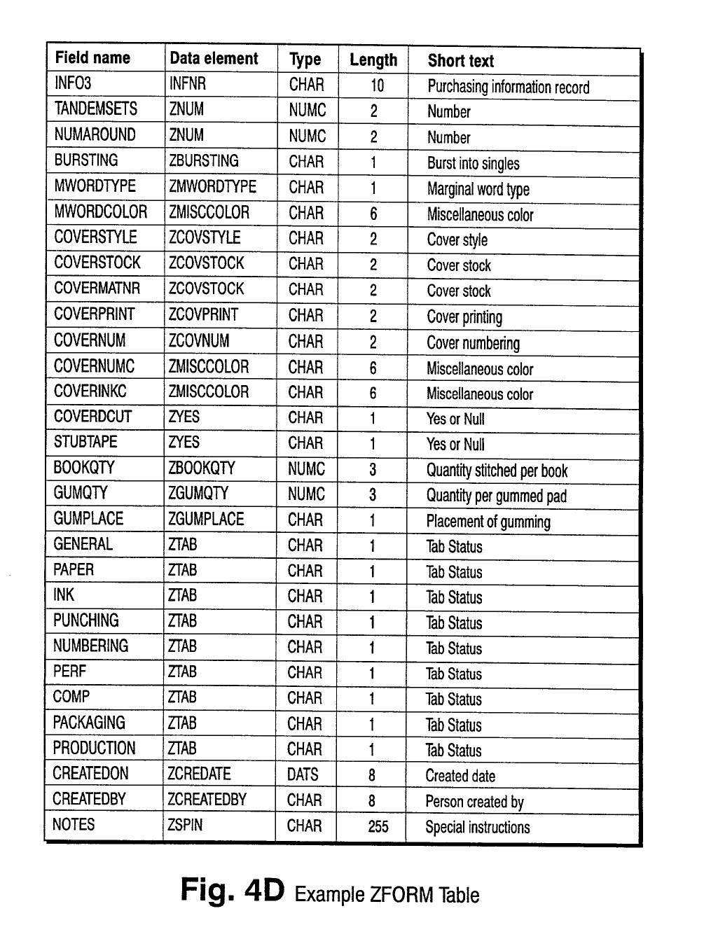

FIGS. 4A-4D show an example “ZFORM” table contents providing form level data for each configuration version of a business form product. The key fields for this table include the ID and EFFECTIVE fields.

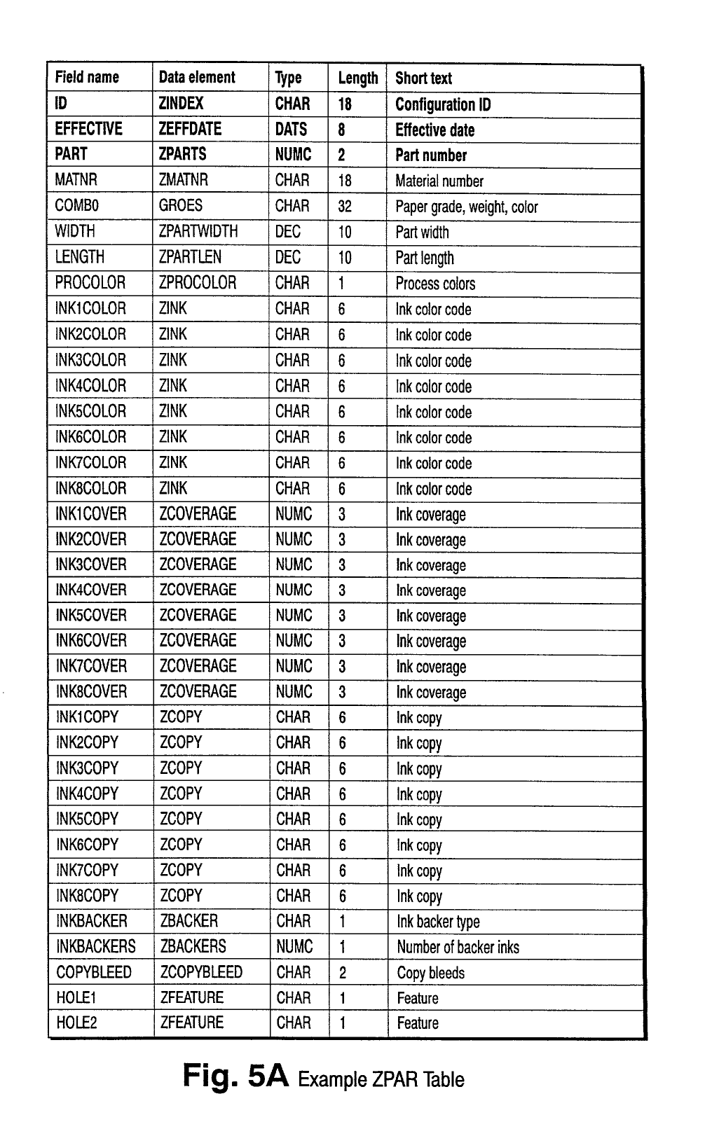

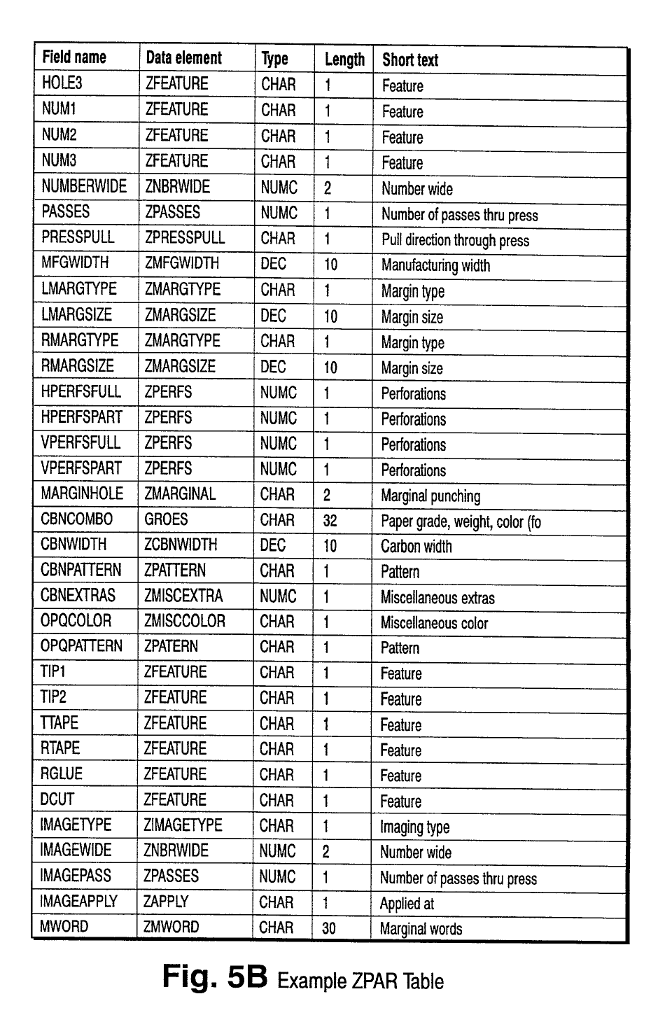

FIGS. 5A-5B show an example “ZPAR” table providing part level data for each configuration. In the example embodiment, the ID, EFFECTIVE and PART fields comprise the key fields.

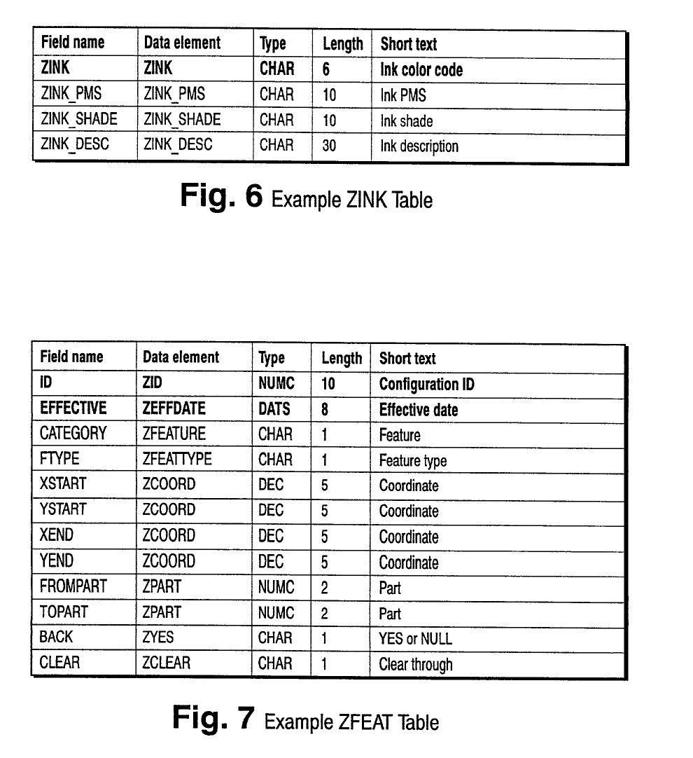

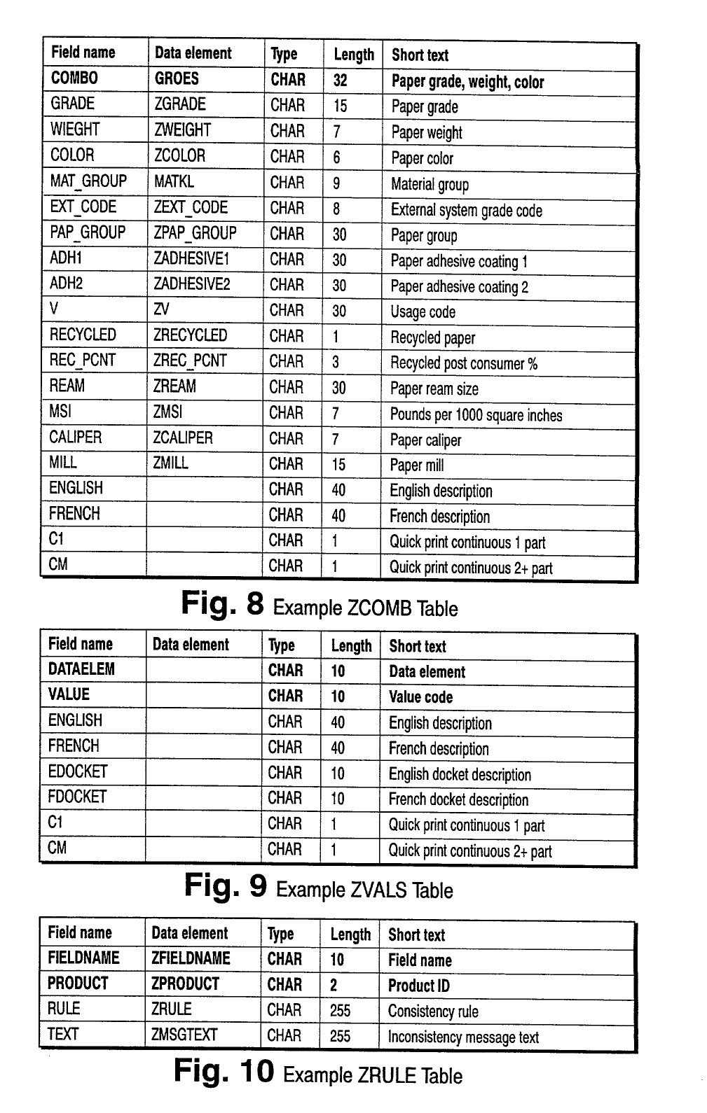

FIG. 6 shows an example “ZINK” table that specifies the allowed ink colors. FIG. 7 shows an example “ZFEAT” table that specifies glue, perforation, tape and carbon pattern feature data for each configuration. The FIG. 8 “ZCOMB” table specifies allowed paper weight, color and grade combinations. FIG. 9 shows an example ZVALS table specifying allowed values for fields other than ink and paper.

The example table shown in FIG. 10 provides field-specific consistency checking. The consistency checks determine whether additional data input must be specified for a configuration before it can be submitted for subsequent processing. Consistency checks are enforced by the front-end interfaces 300 in the example embodiment. If any consistency check fails, the configuration is considered to be inconsistent. An inconsistent configuration can be saved at any time, but it can not be submitted for subsequent processing in the example embodiment until the inconsistencies are resolved. Consistency checks may be performed when a configuration is saved or submitted for subsequent processing. The source of the inconsistency or inconsistencies should be communicated to the user. The following explains some of the terminology used in consistency checks:

If a rule states that a field must be specified, it means that an entry must be made in the field. In other words, the field is required.

If a rule states that a group of fields must be specified together, it means that every field in the group must be specified or no field in the group can be specified. In other words, it is an all or nothing proposition. For example, if A, B, and C represent a group of fields, this logic is represented by the following expressions. Either one evaluates to false if all or none is specified and to true if otherwise.

1. (A specified or B specified or C specified) and not (A specified and B specified and C specified)

2. (A is null or B is null or C is null) and not (A is null and B is null and C is null).

Some example consistency checks for quick print continuous products are listed below:

1. The form name and/or form number must be specified.

2. Face inks and face composition must be specified together. In other words, if there are any face inks specified on any part, then face composition must be specified, and vice versa.

3. Backer inks, back composition, and backer type must be specified together. In other words, if there are any backer inks specified on any part, then back composition and backer type must be specified, and vice versa.

4. Proof type and number of proofs must be specified together.

5. All inconsistent configurations must have status “draft.”

### Example Allowed Values

In the example embodiment, allowed values for the ZQPC table 210 may be categorized by their data element. All fields within a given data element will, generally, have the same allowed values. Records in the ZINK, ZCOMB and ZVALS tables 202, 204, 206 may determine the allowed values of the data element. Only these values may be entered into a field (with that data element) unless that field name has records in the ZRULE table 208. In the example embodiment, for the ZINK table 202 data element, allowed values are listed in the ZINK table. For the GROES data element, allowed values are listed in the ZCOMB table 204. For all other data elements, the allowed values are determined by querying ZVALS table 206. A separate query may be used for each description/data element/product combination. For example, the following SQL query could be used to find allowed values with English descriptions for data element ZDELIVER in a one-part quick print continuous form product:

SELECT Value Edesc FROM Zvals

WHERE Dataelem=“ZDELIVERY” AND NOT Cm IS INITIAL

### Allowed Ranges

Allowed ranges for fields in the ZQPC table are categorized by their data element in the example embodiment. All fields with a given data element will have the same allowed ranges. Records in the ZRULE table determine the allowed ranges of a data element. A value within an allowed range may be entered into a field (with that data element) instead of one of the allowed values. An allowed range check should only be performed when a value that is not an allowed value is entered into a field.

Allowed ranges are determined by querying the ZRULE table. If a query finds any records, the value is valid. It is suggested that a separate query be used for each data element/product combination. Numeric fields should check whether the value entered into a field falls between the upper and lower limits of the range. For example, use the following SQL query to determine if a numeric value (Num) falls within an allowed range for data element ZWIDTH in a one part quick print continuous product.

SELECT *FROM Zrule

WHERE Dataelem=“ZWIDTH” AND NOT Cm IS INITIAL AND Lower [symbol] Num AND Upper [symbol] Num

Character fields do not need to check whether the value entered into a field falls within a range. If any record is found in a query of the ZRULE table for the corresponding data element, then any text value can be entered into the field. For example, use the following SQL query to determine if any character can be entered for data element ZHOLESIZE in a one part quick print continuous product.

SELECT*FROM Zrule

WHERE Dataelem=“ZHOLESIZE” AND NOT Cm IS INITIAL

It is recommended that the allowed range check be performed on all data elements regardless of whether ranges are expected. If an allowed range is added for a data element at a later date, the validation logic will already be in place. The exception to this recommendation is the ZINK and GROES data elements. They will never have allowed ranges so they never need to be checked for allowed ranges.

### Suggestions for Front-End Applications 300

Front-end applications 300 may be written as web servers that interface with end-users 400 via a network 500 such as an intranet or the Internet. In the example embodiment, front-end interfaces 300 may perform as many consistency checks as practical while the user configures a product so the user can react to a problem as it arises rather than at the end of the end of the configuration. It may be desirable in some applications for the front-end interfaces 300 to display only pertinent part specific fields (e.g., if the user is configuring a two-part continuous business form, then no ink, paper or punching fields for parts three and greater should be displayed). In the example embodiment, the front-end interfaces 300 may comprise web-enabled software using HTML and HTTP, but in other applications other configurations are also possible.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

We claim:

1. A method of developing product orders comprising:
developing product variation configuration information through customer interaction outside of a conventional enterprise resource planning application;
storing said product variation configuration information in at least one table;
importing the table into the conventional enterprise resource planning application; and
performing product order related processing with the conventional enterprise resource planning application in response to said imported table.

2. The method of claim 1 wherein the developing step includes allowing the customer to interact with a web-based application.

3. The method of claim 1 wherein the developing step includes allowing the customer to interact with a computer over the Internet.

4. The method of claim 1 wherein the developing step includes providing a multi-level product configuration function, and wherein the conventional enterprise resource planning application provides a native variant configurator that provides only single single product configuration.

5. The method of claim 1 wherein the at least one table comprises at least one configuration table and at least one control table.

6. The method of claim 1 wherein the conventional enterprise resource planning application includes a variant configurator, a router, a bill of materials exploder, a costing function, and a material master.

7. The method of claim 1 wherein the developing step comprises developing a table in a format that is directly compatible with the conventional enterprise resource planning application.

8. A method of developing customized product information comprising:
(a) providing an enterprise resource planning application including a native variant configurator having user interaction capabilities;
(b) facilitating interaction between a customer and a further, non-native variant configurator to develop at least one configuration table; and
(c) importing the configuration table into the enterprise resource planning application such that product configuration information used by the enterprise resource planning application is developed using the non-native variant configurator rather than the native variant configurator.

9. A system for developing product information comprising:
an enterprise resource planning application;
a front end interface external to the enterprise resource planning application, the external front end interface being accessible via a network and developing at least one custom table; and
an importer that reads data from the custom table and imports said data into the enterprise resource planning application for further processing thereby.
